(19) United States
(12) Patent Application Publication
(10) Pub. No.: US 2005/0145167 A1
(43) Pub. Date: Jul. 7, 2005

(54) Adhesive applicator

(76) Inventor: Scott Wilson, New York City, NY (US)

Correspondence Address: SCOTT WILSON, 201 W 54th Street, Manhattan, NY, 10019, US

(21) Appl. No.: 10/666,784

(22) Filed: Sep. 22, 2003

(51) Int. Cl. B05D 1/00; B05C 1/00

(52) U.S. Cl. 118/200; 427/11

(57) ABSTRACT

There has been a need to apply paste adhesive to wide areas using a hand held device. The invention involves a novel way to apply a wide area of paste adhesive to the back of paper, cardboard, film and fabric for mounting purposes. The hand held invention is comprised of a 1/4 inch thick 3×5 inch plastic plate which extrudes adhesive paste through a surrounding plastic sleeve, applying a thin, consistent coating of adhesive to the back surface of the 4×5 photograph. A plastic lid covers the end of the glue applicator so that the contents do not dry out when not in use.

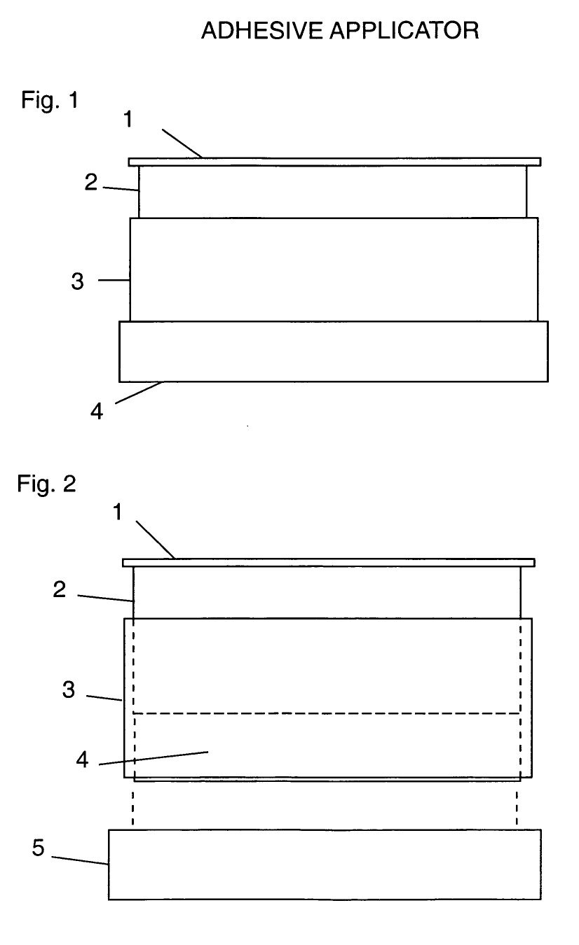

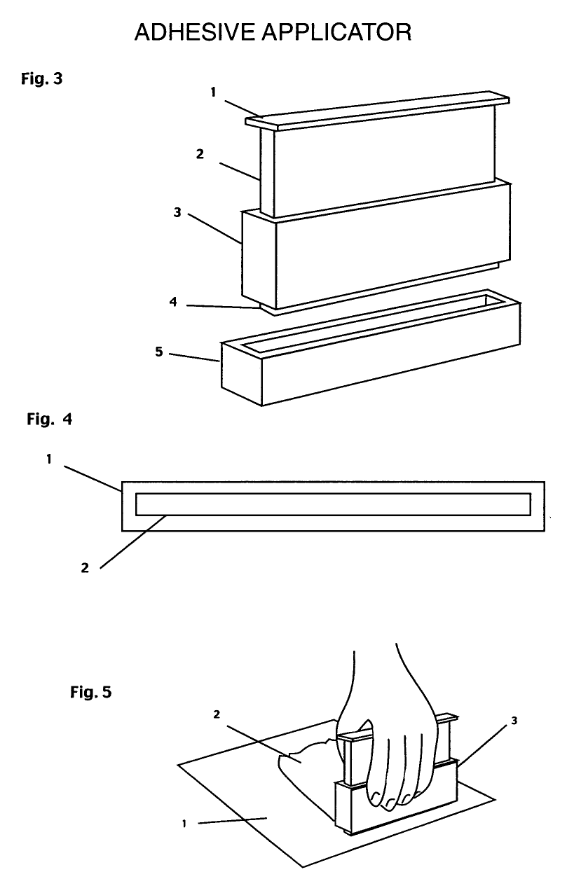

The invention involves a novel way to apply a wide area of paste adhesive to the back of paper, cardboard, film and fabric for mounting purposes. The hand held invention is comprised of a ¼ inch thick 3×5 inch plastic plate which extrudes adhesive paste through a surrounding plastic sleeve, applying a thin, consistent coating of adhesive to the back surface of the 4×5 photograph.

### SUMMARY OF THE INVENTION

It is therefore an object of the invention to provide a novel method for applying paste adhesive to the back of paper, cardboard, film and fabric for mounting purposes.

### BACKGROUND OF THE INVENTION

The invention relates to the method of applying adhesive to paper, cardboard, film and fabric. A search for prior gluing methods revealed the following representitive patents listed below.

U.S. Pat. DES No. 390,075—An invention limited to using liquid adhesive.

U.S. Pat. No. 5,549,751—An invention involving rollers, which cannot be hand held.

U.S. Pat. No. D 356,828—A hand held invention which uses liquid adhesive, and a roller.

U.S. Pat. No. 5,178,717—An invention employing adhesive release tape.

1. A hand held device which applys a consistent, 5″ wide coating of adhesive paste on paper, cardboard, or fabric for mounting purposes.

2. A device which can apply a uniform layer of adhesive on any flat, porous material by means of a hand held 5″ wide plastic applicator.

3. A method for applying a 5″ coating of adhesive paste glue on paper, cardboard, film or fabric, employing a 5″ wide plastic hand held applicator.

4. A hand held plastic device capable of extruding a uniform coating of adhesive paste on the surface of paper, cardboard, or fabric.
